(19) United States
(12) Patent Application Publication
(10) Pub. No.: US 2007/0010318 A1
(43) Pub. Date: Jan. 11, 2007

(54) Light sources and displays in a gaming machine

(76) Inventors: Gene Rigsby, Chicago, IL (US); Victor Mercado, Berwyn, IL (US)

Correspondence Address: JENKENS & GILCHRIST, P.C., 225 WEST WASHINGTON, SUITE 2600, CHICAGO, IL, 60606, US

(21) Appl. No.: 11/484,390

(22) Filed: Jul. 11, 2006

Related U.S. Application Data
(60) Provisional application No. 60/698,026, filed on Jul. 11, 2005.

(51) Int. Cl. A63F 13/00

(52) U.S. Cl. 463/20

(57) ABSTRACT

A gaming machine for conducting a wagering game includes a housing that surrounds a light source. The light source emits at least one color of visible light and may include a microdisplay. In one aspect, the light emitters are coupled to optical fibers that guide visible light from the light source to one or more light emitters (such as a tower light, a lighted button, a marquee, or transparent signage). In another, a microdisplay displays an image that is magnified through one or more lenses and projected onto a transparent substrate. The light source may include an LCD display, a CRT display, an incandescent source, or the like. The microdisplay may include a DLP display, a LCoS display, a plasma display, an OLED display, or the like.

### CROSS REFERENCE TO RELATED APPLICATION

This application claims the benefit of U.S. Provisional Application No. 60/698,026, filed Jul. 11, 2005, entitled “Fiber Optic Lighting And Displays In a Gaming Machine.”

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to gaming machines, and methods for playing wagering games, and more particularly, to a gaming machine having fiber optic lighting and displays.

### BACKGROUND OF THE INVENTION

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for gaming machine manufacturers to continuously develop new games and improved gaming enhancements that will attract frequent play through enhanced entertainment value to the player.

One concept that has been successfully employed to enhance the entertainment value of a game is the concept of a “secondary” or “bonus” game that may be played in conjunction with a “basic” game. The bonus game may comprise any type of game, either similar to or completely different from the basic game, which is entered upon the occurrence of a selected event or outcome in the basic game. Generally, bonus games provide a greater expectation of winning than the basic game and may also be accompanied with more attractive or unusual video displays and/or audio. Bonus games may additionally award players with “progressive jackpot” awards that are funded, at least in part, by a percentage of coin-in from the gaming machine or a plurality of participating gaming machines. Because the bonus game concept offers tremendous advantages in player appeal and excitement relative to other known games, and because such games are attractive to both players and operators, there is a continuing need to develop gaming machines with new types of bonus games to satisfy the demands of players and operators.

Traditional gaming machines include various lighting schemes and display elements in an effort to improve the appearance, aesthetics and appeal of the gaming machine. Numerous elements of a gaming machine are illuminated using these variety of sources, usually resulting in a gaming machine being manufactured having a multitude of light sources including lamps, bulbs, LEDs, and video displays that illuminate all sorts of components associated with the gaming machine such as the gaming machine cabinet, glass art, reels, coin/cup tray, marquee, top box area, signage, buttons, and button panels. One shortcoming of this configuration is that a multitude of light sources requires significant maintenance measures to verify that all lighting components are functioning and replace or repair them if they are not functioning properly.

Another shortcoming is that each light source (such as an incandescent bulb) consumes a significant amount of power and each light source requires its own cabling and must be individually addressed or controlled through a complex arrangement of electronics, cabling and connectors, and software, rendering servicing and repair of such gaming machines time-consuming and labor-intensive.

In upright gaming machines employing video displays, the size of the video display is directly related to the size of the footprint of the gaming machine. The trend toward larger-sized LCD displays will not necessarily be embraced by manufacturers of video-type gaming machines because increasing footprint size decreases the total number of machines that can be arranged on a floor.

Furthermore, gaming machines utilizing traditional video displays do not provide for the ability to define a custom display size without the use of a custom projection source. On traditional LCD displays, areas that occupy less than the total viewable area can be displayed but black bars must be displayed in those areas where no image is displayed, which is visually unappealing and can also lead to undesirable burn-in and other visual artifacts. In displays utilizing a projection source, to project a custom display size onto a screen, a custom projection source is needed. Such projection sources are not amenable for use in displaying both conventional and non-conventional display sizes and resolutions.

Finally, there does not exist today a gaming machine having a single projection source that feeds distinct and multiple displays. The present invention is related to solving one or more of these and other problems.

### SUMMARY OF THE INVENTION

According to one aspect of the present invention, a gaming machine for conducting a wagering game includes a housing and a light source coupled to the housing. The light source emits at least one color of visible light. The gaming machine further includes a first light emitter coupled to the housing and a second light emitter coupled to the housing. The gaming machine further includes a first plurality of optical fibers and a second plurality of optical fibers. The first plurality of optical fibers have first ends optically coupled to the light source and second ends optically coupled to the first light emitter. The second plurality of optical fibers have first ends optically coupled to the light source and second ends optically coupled to the second light emitter.

According to another aspect of the invention, a method of conducting a wagering game on a gaming machine comprises a housing and at least one light source coupled to the housing, the light source emitting visible light. The gaming machine further includes a first emitter coupled to a first portion of the housing and a second emitter coupled to a second portion of the housing. The gaming machine further includes a first plurality of optical fibers and a second plurality of optical fibers. The first plurality of optical fibers have first ends optically coupled to the light source and second ends optically coupled to the first light emitter. The second plurality of optical fibers have first ends optically coupled to the light source and second ends optically coupled to the second light emitter.

According to yet another aspect of the invention, a gaming system comprises a value input device for receiving a wager and a video source generating a representation of a randomly-selected outcome selected from a plurality of possible outcomes, the plurality of outcomes including at least one winning outcome. The system further includes a video display for displaying the representation, the video display comprising an array of fiber tubes, the fiber tubes arranged in groups within the array. The system includes a plurality of optical fibers having first ends and second ends, each first end optically coupled to the video source and each second end optically coupled to a respective one of the groups of fiber tubes.

According to still another aspect, a gaming machine includes a housing, a projection source disposed in the housing, the projection source emitting at least one image relating to a wagering game that is played on the gaming machine; a primary display unit coupled to a first portion of the housing; a secondary display unit coupled to a second portion of the housing; a first optics disposed generally between the projection source and the primary display unit, the first optics magnifying images emitted by the projection source for display on the primary display unit; and a second optics disposed generally between the projection source and the secondary display unit, the second optics magnifying images emitted by the projection source for display on the secondary display unit. The display units may include a transparent substrate made of glass or plastic.

The projection source may include a microdisplay or a display selected from the group consisting of an electroluminescence source, a vacuum fluorescence source, a substrate having tilting or deforming micro-mirrors (DMD), a digital light processing (DLP) source, a liquid-crystal-on-silicon (LCoS) substrate, a plasma display, an incandescent source, a high-intensity LED, an LCD display, a silicon-based organic LED (“OLED”) display, and a laser. In some aspects, the projection source may include a first source area that emits a first set of images relating to the wagering game and a second source area that emits a second set of images relating to the wagering game, the first set of images being displayed on the primary display unit, the second set of images being displayed on the secondary display unit.

According to a still further aspect, a gaming machine includes a first wager input device for receiving a wager to play a first wagering game on the gaming machine; a second wager input device for receiving a wager to play a second wagering game on the gaming machine, the second wagering game capable of being played concurrently with the first wagering game; a housing; a projection source, which may include a microdisplay, disposed in the housing, the projection source emitting an image relating to the first wagering game or the second wagering game; at least two display units coupled to the housing; an optics divider optically coupled to the projection source to divide the image into a number of image sections corresponding to the number of display units; and optics optically coupled to the optics divider to magnify and project a first image section of the image sections to a first one of the display units and a second image section of the image sections to a second one of the display units. The display units may be disposed on opposite sides of the gaming machine, and the optics may include a prism.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1a is a perspective view of a free standing gaming machine embodying the present invention;

FIG. 1b is a perspective view of a handheld gaming machine embodying the present invention;

FIG. 2 is a block diagram of a control system suitable for operating the gaming machine;

FIG. 3 is a diagram of the internal components of a gaming machine according to one embodiment of the present invention;

FIG. 4 is a diagram of the internal components of a gaming machine according to another embodiment of the present invention;

FIG. 5 is a diagram of a gaming system including a magnified display;

FIG. 6 is cross-section of a display of the gaming system of FIG. 5;

FIG. 7a is front view of a portion of the display of FIG. 5; and

FIG. 7b is a cross-section of the display portion in FIG. 7a.

FIG. 8 is a side view of a gaming machine according to another embodiment of the present invention.

FIG. 9 is a side view of a gaming machine according to yet another embodiment of the present invention.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

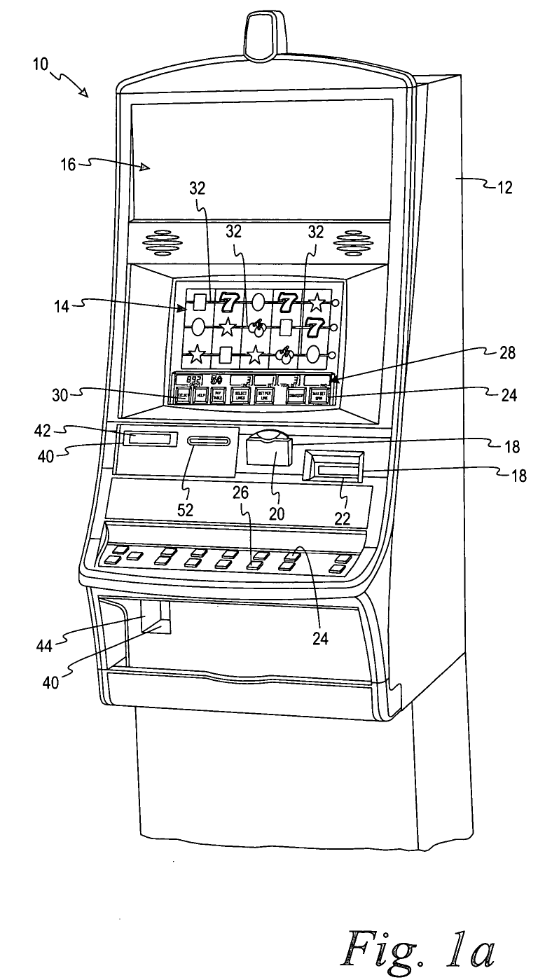

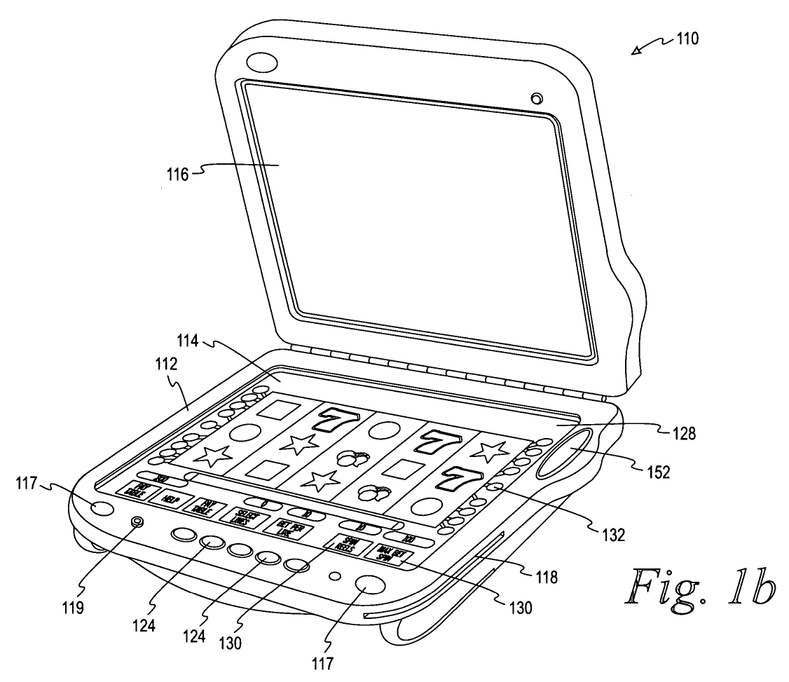

Referring to FIG. 1a, a gaming machine 10 is used in gaming establishments such as casinos. With regard to the present invention, the gaming machine 10 may be any type of gaming machine and may have varying structures and methods of operation. For example, the gaming machine 10 may be an electromechanical gaming machine configured to play mechanical slots, or it may be an electronic gaming machine configured to play a video casino game, such as blackjack, slots, keno, poker, blackjack, roulette, etc.

The gaming machine 10 comprises a housing 12 and includes input devices, including a value input device 18 and a player input device 24. For output the gaming machine 10 includes a primary display 14 for displaying information about the basic wagering game. The primary display 14 can also display information about a bonus wagering game and a progressive wagering game. The gaming machine 10 may also include a secondary display 16 for displaying game events, game outcomes, and/or signage information. While these typical components found in the gaming machine 10 are described below, it should be understood that numerous other elements may exist and may be used in any number of combinations to create various forms of a gaming machine 10.

The value input device 18 may be provided in many forms, individually or in combination, and is preferably located on the front of the housing 12. The value input device 18 receives currency and/or credits that are inserted by a player. The value input device 18 may include a coin acceptor 20 for receiving coin currency (see FIG. 1a). Alternatively, or in addition, the value input device 18 may include a bill acceptor 22 for receiving paper currency. Furthermore, the value input device 18 may include a ticket reader, or barcode scanner, for reading information stored on a credit ticket, a card, or other tangible portable credit storage device. The credit ticket or card may also authorize access to a central account, which can transfer money to the gaming machine 10.

The player input device 24 comprises a plurality of push buttons 26 on a button panel for operating the gaming machine 10. In addition, or alternatively, the player input device 24 may comprise a touch screen 28 mounted by adhesive, tape, or the like over the primary display 14 and/or secondary display 16. The touch screen 28 contains soft touch keys 30 denoted by graphics on the underlying primary display 14 and used to operate the gaming machine 10. The touch screen 28 provides players with an alternative method of input. A player enables a desired function either by touching the touch screen 28 at an appropriate touch key 30 or by pressing an appropriate push button 26 on the button panel. The touch keys 30 may be used to implement the same functions as push buttons 26. Alternatively, the push buttons 26 may provide inputs for one aspect of the operating the game, while the touch keys 30 may allow for input needed for another aspect of the game.

The various components of the gaming machine 10 may be connected directly to, or contained within, the housing 12, as seen in FIG. 1a, or may be located outboard of the housing 12 and connected to the housing 12 via a variety of different wired or wireless connection methods. Thus, the gaming machine 10 comprises these components whether housed in the housing 12, or outboard of the housing 12 and connected remotely.

The operation of the basic wagering game is displayed to the player on the primary display 14. The primary display 14 can also display the bonus game associated with the basic wagering game. The primary display 14 may take the form of a cathode ray tube (CRT), a high resolution LCD, a plasma display, an LED, or any other type of display suitable for use in the gaming machine 10. As shown, the primary display 14 includes the touch screen 28 overlaying the entire display (or a portion thereof) to allow players to make game-related selections. Alternatively, the primary display 14 of the gaming machine 10 may include a number of mechanical reels to display the outcome in visual association with at least one payline 32. In the illustrated embodiment, the gaming machine 10 is an “upright” version in which the primary display 14 is oriented vertically relative to the player. Alternatively, the gaming machine may be a “slant-top” version in which the primary display 14 is slanted at about a thirty-degree angle toward the player of the gaming machine 10.

A player begins play of the basic wagering game by making a wager via the value input device 18 of the gaming machine 10. A player can select play by using the player input device 24, via the buttons 26 or the touch screen keys 30. The basic game consists of a plurality of symbols arranged in an array, and includes at least one payline 32 that indicates one or more outcomes of the basic game. Such outcomes are randomly selected in response to the wagering input by the player. At least one of the plurality of randomly-selected outcomes may be a start-bonus outcome, which can include any variations of symbols or symbol combinations triggering a bonus game.

In some embodiments, the gaming machine 10 may also include a player information reader 52 that allows for identification of a player by reading a card with information indicating his or her true identity. The player information reader 52 is shown in FIG. 1a as a card reader, but may take on many forms including a ticket reader, bar code scanner, RFID transceiver or computer readable storage medium interface. Currently, identification is generally used by casinos for rewarding certain players with complimentary services or special offers. For example, a player may be enrolled in the gaming establishment's loyalty club and may be awarded certain complimentary services as that player collects points in his or her player-tracking account. The player inserts his or her card into the player information reader 52, which allows the casino's computers to register that player's wagering at the gaming machine 10. The gaming machine 10 may use the secondary display 16 or other dedicated player-tracking display for providing the player with information about his or her account or other player-specific information. Also, in some embodiments, the information reader 52 may be used to restore game assets that the player achieved and saved during a previous game session.

Depicted in FIG. 1b is a handheld or mobile gaming machine 110. Like the free standing gaming machine 10, the handheld gaming machine 110 is preferably an electronic gaming machine configured to play a video casino game such as, but not limited to, blackjack, slots, keno, poker, blackjack, and roulette. The handheld gaming machine 110 comprises a housing or casing 112 and includes input devices, including a value input device 118 and a player input device 124. For output the handheld gaming machine 110 includes, but is not limited to, a primary display 114, a secondary display 116, one or more speakers 117, one or more player-accessible ports 119 (e.g., an audio output jack for headphones, a video headset jack, etc.), and other conventional I/O devices and ports, which may or may not be player-accessible. In the embodiment depicted in FIG. 1b, the handheld gaming machine 110 comprises a secondary display 116 that is rotatable relative to the primary display 114. The optional secondary display 116 may be fixed, movable, and/or detachable/attachable relative to the primary display 114. Either the primary display 114 and/or secondary display 116 may be configured to display any aspect of a non-wagering game, wagering game, secondary games, bonus games, progressive wagering games, group games, shared-experience games or events, game events, game outcomes, scrolling information, text messaging, emails, alerts or announcements, broadcast information, subscription information, and handheld gaming machine status.

The player-accessible value input device 118 may comprise, for example, a slot located on the front, side, or top of the casing 112 configured to receive credit from a stored-value card (e.g., casino card, smart card, debit card, credit card, etc.) inserted by a player. In another aspect, the player-accessible value input device 118 may comprise a sensor (e.g., an RF sensor) configured to sense a signal (e.g., an RF signal) output by a transmitter (e.g., an RF transmitter) carried by a player. The player-accessible value input device 118 may also or alternatively include a ticket reader, or barcode scanner, for reading information stored on a credit ticket, a card, or other tangible portable credit or funds storage device. The credit ticket or card may also authorize access to a central account, which can transfer money to the handheld gaming machine 110.

Still other player-accessible value input devices 118 may require the use of touch keys 130 on the touch-screen display (e.g., primary display 114 and/or secondary display 116) or player input devices 124. Upon entry of player identification information and, preferably, secondary authorization information (e.g., a password, PIN number, stored value card number, predefined key sequences, etc.), the player may be permitted to access a player's account. As one potential optional security feature, the handheld gaming machine 110 may be configured to permit a player to only access an account the player has specifically set up for the handheld gaming machine 110. Other conventional security features may also be utilized to, for example, prevent unauthorized access to a player's account, to minimize an impact of any unauthorized access to a player's account, or to prevent unauthorized access to any personal information or funds temporarily stored on the handheld gaming machine 110.

The player-accessible value input device 118 may itself comprise or utilize a biometric player information reader which permits the player to access available funds on a player's account, either alone or in combination with another of the aforementioned player-accessible value input devices 118. In an embodiment wherein the player-accessible value input device 118 comprises a biometric player information reader, transactions such as an input of value to the handheld device, a transfer of value from one player account or source to an account associated with the handheld gaming machine 110, or the execution of another transaction, for example, could all be authorized by a biometric reading, which could comprise a plurality of biometric readings, from the biometric device.

Alternatively, to enhance security, a transaction may be optionally enabled only by a two-step process in which a secondary source confirms the identity indicated by a primary source. For example, a player-accessible value input device 118 comprising a biometric player information reader may require a confirmatory entry from another biometric player information reader 152, or from another source, such as a credit card, debit card, player ID card, fob key, PIN number, password, hotel room key, etc. Thus, a transaction may be enabled by, for example, a combination of the personal identification input (e.g., biometric input) with a secret PIN number, or a combination of a biometric input with a fob input, or a combination of a fob input with a PIN number, or a combination of a credit card input with a biometric input. Essentially, any two independent sources of identity, one of which is secure or personal to the player (e.g., biometric readings, PIN number, password, etc.) could be utilized to provide enhanced security prior to the electronic transfer of any funds. In another aspect, the value input device 118 may be provided remotely from the handheld gaming machine 110.

The player input device 124 comprises a plurality of push buttons on a button panel for operating the handheld gaming machine 110. In addition, or alternatively, the player input device 124 may comprise a touch screen 128 mounted to a primary display 114 and/or secondary display 116. In one aspect, the touch screen 128 is matched to a display screen having one or more selectable touch keys 130 selectable by a user's touching of the associated area of the screen using a finger or a tool, such as a stylus pointer. A player enables a desired function either by touching the touch screen 128 at an appropriate touch key 130 or by pressing an appropriate push button 126 on the button panel. The touch keys 130 may be used to implement the same functions as push buttons 126. Alternatively, the push buttons may provide inputs for one aspect of the operating the game, while the touch keys 130 may allow for input needed for another aspect of the game. The various components of the handheld gaming machine 110 may be connected directly to, or contained within, the casing 112, as seen in FIG. 1b, or may be located outboard of the casing 112 and connected to the casing 112 via a variety of hardwired (tethered) or wireless connection methods. Thus, the handheld gaming machine 110 may comprise a single unit or a plurality of interconnected parts (e.g., wireless connections) which may be arranged to suit a player's preferences.

The operation of the basic wagering game on the handheld gaming machine 110 is displayed to the player on the primary display 114. The primary display 114 can also display the bonus game associated with the basic wagering game. The primary display 114 preferably takes the form of a high resolution LCD, a plasma display, an LED, or any other type of display suitable for use in the handheld gaming machine 110. The size of the primary display 114 may vary from, for example, about a 2-3″ display to a 15″ or 17″ display. In at least some aspects, the primary display 114 is a 7″-10″ display. As the weight of and/or power requirements of such displays decreases with improvements in technology, it is envisaged that the size of the primary display may be increased. Optionally, coatings or removable films or sheets may be applied to the display to provide desired characteristics (e.g., anti-scratch, anti-glare, bacterially-resistant and anti-microbial films, etc.). In at least some embodiments, the primary display 114 and/or secondary display 116 may have a 16:9 aspect ratio or other aspect ratio (e.g., 4:3). The primary display 114 and/or secondary display 116 may also each have different resolutions, different color schemes, and different aspect ratios.

As with the free standing gaming machine 10, a player begins play of the basic wagering game on the handheld gaming machine 110 by making a wager (e.g., via the value input device 18 or an assignment of credits stored on the handheld gaming machine via the touch screen keys 130, player input device 124, or buttons 126) on the handheld gaming machine 110. In at least some aspects, the basic game may comprise a plurality of symbols arranged in an array, and includes at least one payline 132 that indicates one or more outcomes of the basic game. Such outcomes are randomly selected in response to the wagering input by the player. At least one of the plurality of randomly selected outcomes may be a start-bonus outcome, which can include any variations of symbols or symbol combinations triggering a bonus game.

In some embodiments, the player-accessible value input device 118 of the handheld gaming machine 110 may double as a player information reader 152 that allows for identification of a player by reading a card with information indicating the player's identity (e.g., reading a player's credit card, player ID card, smart card, etc.). The player information reader 152 may alternatively or also comprise a bar code scanner, RFID transceiver or computer readable storage medium interface. In one presently preferred aspect, the player information reader 152, shown by way of example in FIG. 1b, comprises a biometric sensing device.

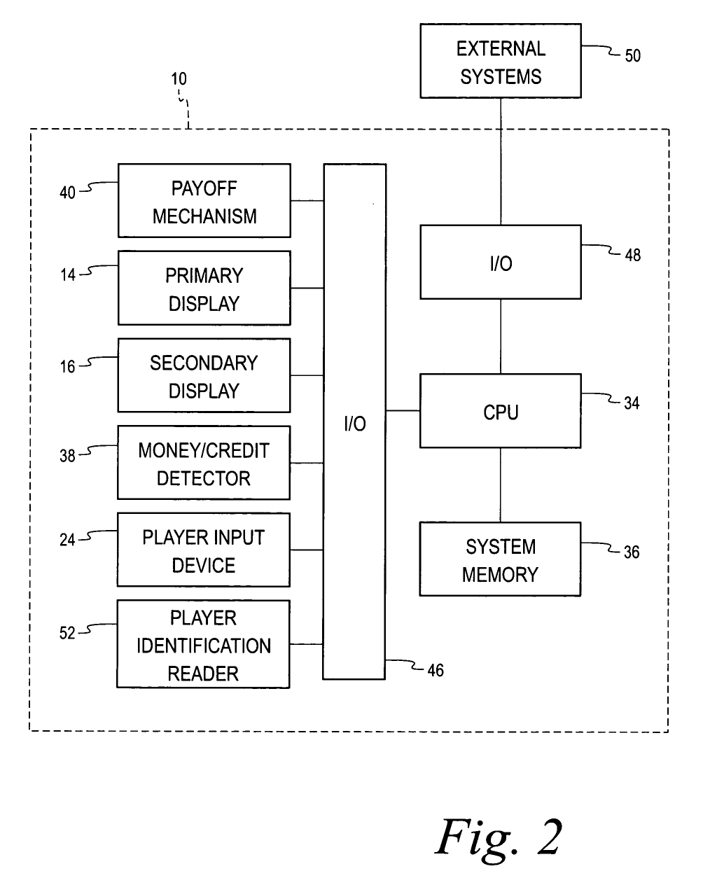

Turning now to FIG. 2, the various components of the gaming machine 10 are controlled by a central processing unit (CPU) 34, also referred to herein as a controller or processor (such as a microcontroller or microprocessor). To provide gaming functions, the controller 34 executes one or more game programs stored in a computer readable storage medium, in the form of memory 36. The controller 34 performs the random selection (using a random number generator (RNG)) of an outcome from the plurality of possible outcomes of the wagering game. Alternatively, the random event may be determined at a remote controller. The remote controller may use either an RNG or pooling scheme for its central determination of a game outcome. It should be appreciated that the controller 34 may include one or more microprocessors, including but not limited to a master processor, a slave processor, and a secondary or parallel processor.

The controller 34 is also coupled to the system memory 36 and a money/credit detector 38. The system memory 36 may comprise a volatile memory (e.g., a random-access memory (RAM)) and a non-volatile memory (e.g., an EEPROM). The system memory 36 may include multiple RAM and multiple program memories. The money/credit detector 38 signals the processor that money and/or credits have been input via the value input device 18. Preferably, these components are located within the housing 12 of the gaming machine 10. However, as explained above, these components may be located outboard of the housing 12 and connected to the remainder of the components of the gaming machine 10 via a variety of different wired or wireless connection methods.

As seen in FIG. 2, the controller 34 is also connected to, and controls, the primary display 14, the player input device 24, and a payoff mechanism 40. The payoff mechanism 40 is operable in response to instructions from the controller 34 to award a payoff to the player in response to certain winning outcomes that might occur in the basic game or the bonus game(s). The payoff may be provided in the form of points, bills, tickets, coupons, cards, etc. For example, in FIG. 1a, the payoff mechanism 40 includes both a ticket printer 42 and a coin outlet 44. However, any of a variety of payoff mechanisms 40 well known in the art may be implemented, including cards, coins, tickets, smartcards, cash, etc. The payoff amounts distributed by the payoff mechanism 40 are determined by one or more pay tables stored in the system memory 36.

Communications between the controller 34 and both the peripheral components of the gaming machine 10 and external systems 50 occur through input/output (I/O) circuits 46, 48. More specifically, the controller 34 controls and receives inputs from the peripheral components of the gaming machine 10 through the input/output circuits 46. Further, the controller 34 communicates with the external systems 50 via the I/O circuits 48 and a communication path (e.g., serial, parallel, IR, RC, 10bT, etc.). The external systems 50 may include a gaming network, other gaming machines, a gaming server, communications hardware, or a variety of other interfaced systems or components. Although the I/O circuits 46, 48 may be shown as a single block, it should be appreciated that each of the I/O circuits 46, 48 may include a number of different types of I/O circuits.

Controller 34, as used herein, comprises any combination of hardware, software, and/or firmware that may be disposed or resident inside and/or outside of the gaming machine 10 that may communicate with and/or control the transfer of data between the gaming machine 10 and a bus, another computer, processor, or device and/or a service and/or a network. The controller 34 may comprise one or more controllers or processors. In FIG. 2, the controller 34 in the gaming machine 10 is depicted as comprising a CPU, but the controller 34 may alternatively comprise a CPU in combination with other components, such as the I/O circuits 46, 48 and the system memory 36. The controller 34 may reside partially or entirely inside or outside of the machine 10. The control system for a handheld gaming machine 110 may be similar to the control system for the free standing gaming machine 10 except that the functionality of the respective on-board controllers may vary.

The gaming machines 10,110 may communicate with external systems 50 (in a wired or wireless manner) such that each machine operates as a “thin client,” having relatively less functionality, a “thick client,” having relatively more functionality, or through any range of functionality therebetween (e.g., a “rich client”). As a generally “thin client,” the gaming machine may operate primarily as a display device to display the results of gaming outcomes processed externally, for example, on a server as part of the external systems 50. In this “thin client” configuration, the server executes game code and determines game outcomes (e.g., with a random number generator), while the controller 34 on board the gaming machine processes display information to be displayed on the display(s) of the machine. In an alternative “rich client” configuration, the server determines game outcomes, while the controller 34 on board the gaming machine executes game code and processes display information to be displayed on the display(s) of the machines. In yet another alternative “thick client” configuration, the controller 34 on board the gaming machine 110 executes game code, determines game outcomes, and processes display information to be displayed on the display(s) of the machine. Numerous alternative configurations are possible such that the aforementioned and other functions may be performed onboard or external to the gaming machine as may be necessary for particular applications. It should be understood that the gaming machines 10,110 may take on a wide variety of forms such as a free standing machine, a portable or handheld device primarily used for gaming, a mobile telecommunications device such as a mobile telephone or personal daily assistant (PDA), a counter top or bar top gaming machine, or other personal electronic device such as a portable television, MP3 player, entertainment device, etc.

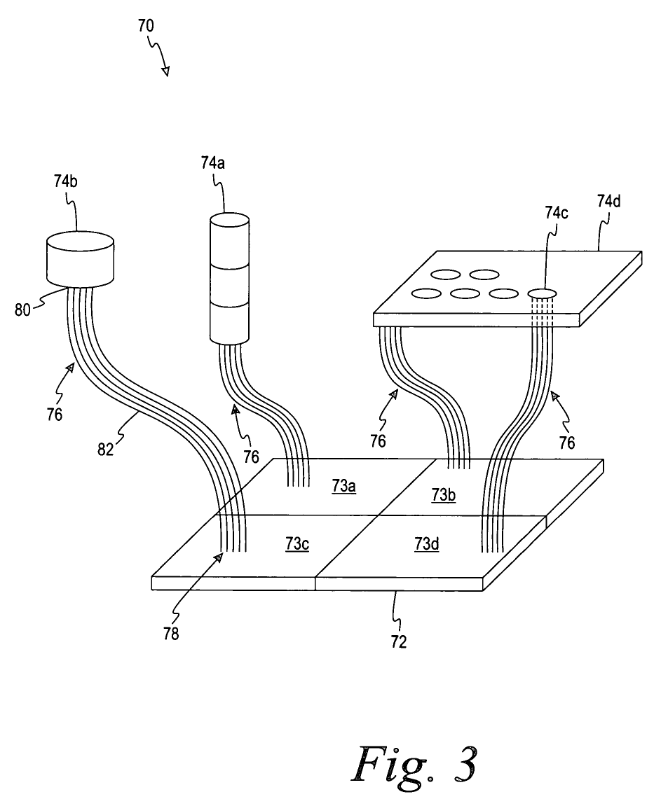

Turning now to FIG. 3, a diagram of a gaming machine 10 according to a first embodiment of the present invention is depicted. The gaming machine 10 includes a lighting system 70 which comprises a light source 72, a plurality of light emitters 74 and a plurality of fiber optic bundles 76 or groups. The light source 72 emits visible light of one or more colors or wavelengths. Preferably the light source 72 is an LCD display capable of displaying multiple graphical images or color regions simultaneously on the display. In this embodiment, the light source 72 is an LCD display having four source areas 73a,b,c,d, which may be configured to produce four separate light signals, colors, or graphic displays. Although the source areas 73a,b,c,d of the light source 72 are shown as equally sized, the source areas 73a,b,c,d may be of varying sizes depending on the demands of the lighting system 70. Furthermore, the number of source areas 73a,b,c,d may be varied according to the amount of lighting in the system 70. The light source 72 may alternatively be any form of light producing elements including a CRT video display, a plasma display, an incandescent light, an LED, an organic LED (“OLED”), and a laser.

The fiber optic bundles 76 are formed of a plurality of optical fibers 82, each fiber having a first end 78 and a second end 80. The first ends 78 of the optical fibers 82 are located adjacent to the light source 72, and are thus optically coupled thereto, as seen in FIG. 3. This optical coupling is accomplished by ensuring close proximity between the first ends 78 of the optical fibers 82 and the light source 72 through the use of any optically transparent adhesive, or other similar method. The second ends 80 of the optical fibers 82 are optically coupled to a plurality of light emitters 74. The light emitters 74 comprise the various light emitting elements of the gaming machine 10, including signs, displays, and signals. For example, the light emitters 74 may include a tower light 74a on the gaming machine 10, a service light 74b, backlit buttons 74c or button panels 74d. Many other light emitters 74 may be utilized, including but not limited to cabinet interior lighting, cabinet exterior lighting (e.g. glass art, reel viewing area, coin/cup tray), marquee lighting, top box lighting, game and game bank signage, progressive displays, and peripheral signage. The light emitters 74 are either transparent or translucent to permit light passing through the optical fibers 82 to pass through and exit from the light emitters 74. Thus, the light emitters 74 may comprise glass, plastic, or other materials which permit the passage of visible light.

Preferably the light source 72 is positioned within the housing 12 of the gaming machine 10 where it may be secured and protected from damage or tampering. The fiber optic bundles 76 are also preferably located substantially within the housing 12 and routed to the locations of the various light emitters 74a,b,c,d on the gaming machine 10. The light emitters 74 are positioned and connected on the exterior of the housing 12 to permit the light passing through the emitters 74 to be visible to a player of the gaming machine 10. It should be understood that the light emitters 74 may be positioned in various places on the housing 12, including the top, front, sides, and back of the housing 12, to accomplish various lighting purposes.

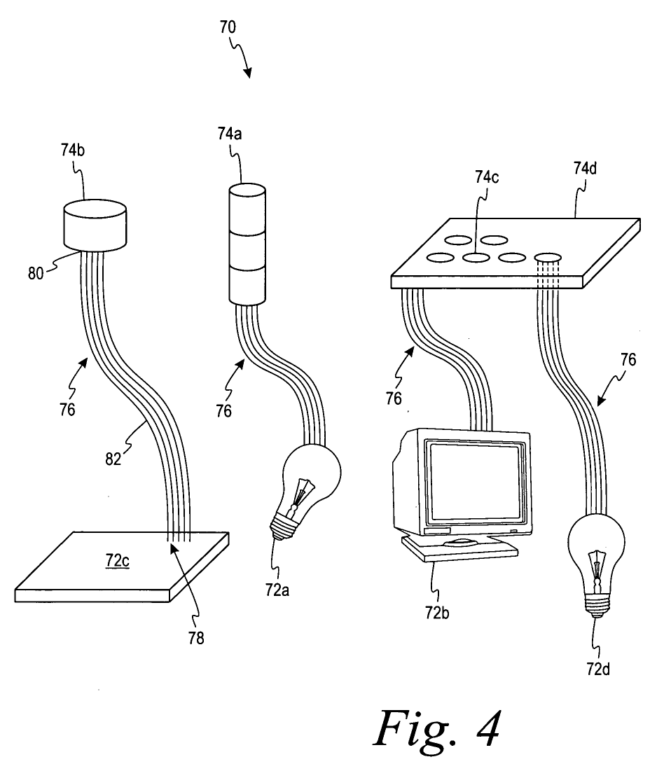

Turning to FIG. 4, an alternative embodiment of the gaming machine 10 incorporating the present invention is depicted. In this alternative embodiment, multiple light sources 72a,b,c,d are utilized in the lighting system 70, rather than a single light source 72 with multiple source areas 73. Thus, the first ends 78 of the various fiber optic bundles 76 are optically coupled to different light sources 72 as seen in FIG. 4. The various light sources 72a,b,c,d may be the same type of source (e.g. LCD display) or may be of differing types as may be needed to accomplish the goals of the lighting system 70. Furthermore, the various light sources 72a,b,c,d may produce light of one color, differing colors, or varying colors over time. Preferably, each light emitter 74a,b,c,d is coupled to only one light source 72a,b,c,d via one fiber optic bundle 76 as seen in FIG. 4. The various light emitters 74 may be located both exterior and interior to the housing 12 for a variety of lighting purposes, as explained herein.

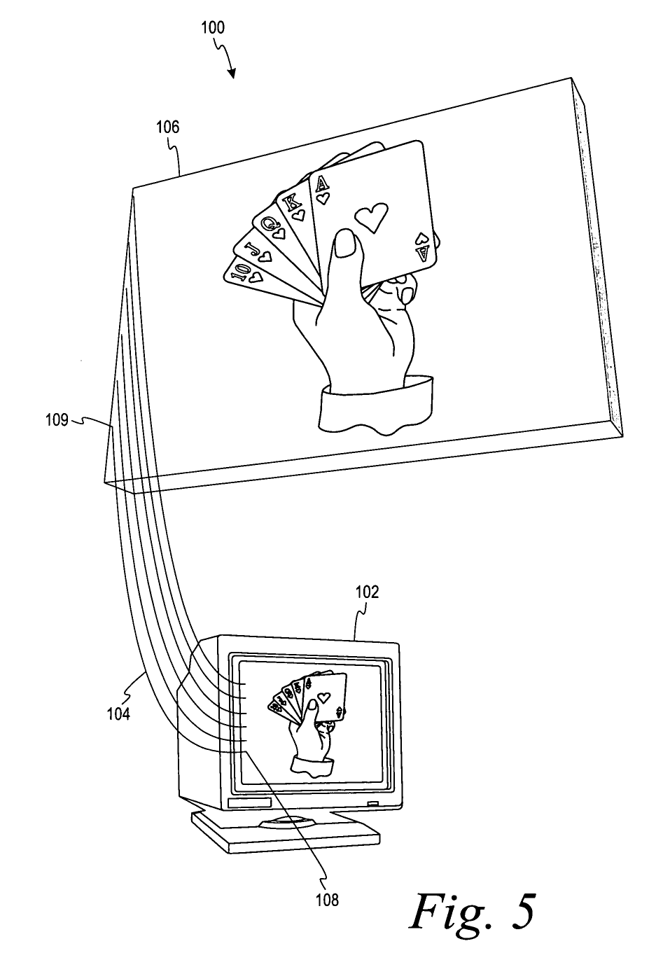

In FIG. 5, an alternate embodiment of the present invention is depicted which is a gaming system that includes a magnified display 100. The magnified display 100 may be employed in conjunction with a single gaming machine 10, or a plurality of gaming machines 10 arranged as a gaming system. Nonetheless the gaming system comprises at least one gaming machine 10 having a value input device 18 for accepting a wager. The magnified display 100 includes a graphics or video source 102, a plurality of optical fibers 104 and a video display 106. The video source 102 is preferably a CRT video monitor which displays any variety of game related graphics, video, and other information. For example, the video source 102 may display a slot reel game, a poker game, or any other game or portions of gameplay thereof that includes a representation of a random outcome of a game of chance. Preferably the video source 102 is mounted within the housing 12 of the gaming machine 10, but may be remote from the gaming machine 10 and connected (wirelessly or wired) to receive graphical transmissions from the gaming machine 10. In this way, the remote video source 102 may be employed as part of a gaming system. The video source 102 includes an array of source pixels which generate the graphical images transmitted from the video source 102. The array of source pixels is preferably arranged as a rectangular two dimensional array having a fixed height and width of pixels. For example, a CRT display video source 102 may be configured to have an array of source pixels arranged in a 800×600 configuration (480,000 total source pixels 108). Numerous other shapes and configurations of source pixels are possible on the video source 102.

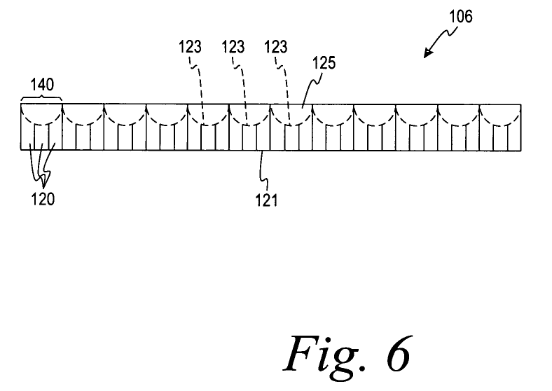

The optical fibers 104 each have a first end 108 and a second end 109. The first ends 108 of the optical fibers 104 are located adjacent to the video source 102, and are thus optically coupled thereto, as seen in FIG. 5. This optical coupling is accomplished by ensuring close proximity between the first ends 108 of the optical fibers 104 and the video source 102 through the use of any optically transparent adhesive, or other similar method. The second ends 109 of the optical fibers 104 are optically connected to the video display 106, as seen in FIGS. 5 and 6. In FIG. 5, only a portion of the optical fibers 104 are displayed for clarity. In practice, the first ends 108 of the optical fibers 104 would cover the surface of the CRT video source 102.

The video display 106 comprises a display surface 121 to which the second ends 109 of the optical fibers 104 are connected. The display surface 121 is transparent or translucent to permit the light passing through the optical fibers 104 to pass through the video display 106 and be visible by a viewer of the display 106. The video display 106 comprises a plurality of relatively short fiber strands or tubes 120 (see FIG. 6) arranged in an array to form display pixels which display the graphical images transmitted from the video source 102 to the video display 106 via the optical fibers 104. The array of display pixels is preferably arranged as a rectangular two dimensional array having a fixed height and width of pixels. Numerous other shapes and configurations of display source pixels are possible on the video display 10.

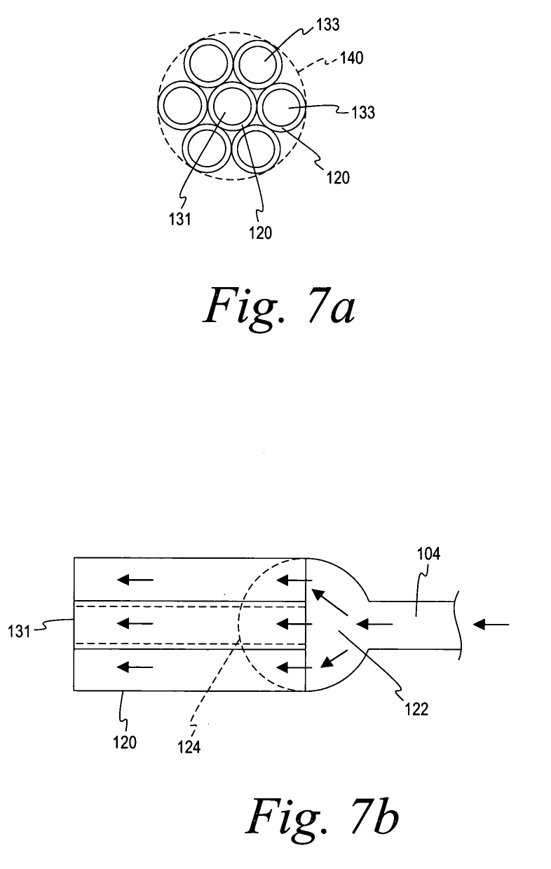

Turning to FIG. 6, a cross-section of the video display 106 is depicted. The display pixels of the video display 106 are formed by a plurality of fiber tubes 120 arranged in an array. A front side of the fiber tubes 120 form the display surface 121. A plurality of tubes 120 are bundled into groups 140 which are coupled to individual second ends 109 of the optical fibers 104 (See FIGS. 7a and 7b). A plurality of concave portions 123 are formed on a rear surface 125 of the video display 106, whereby a group 140 of fiber tubes 120 is collectively terminated in one concave portion 123.

As seen in FIGS. 7a and 7b, seven fiber tubes 120 (a central tube 131 surrounded by six circumferentially arranged outer tubes 133) comprise one group 140. As seen in FIG. 7b, each group 140 includes a concave portion 123 located on the rear surface 125 of the display 106. The second end 109 of each optical fiber 104 is terminated in a convex portion 122. The convex portions 122 of the optical fibers 104 are coupled to the concave portions 123 on the rear surface 125 of the video display 106. In this way, light passing through one optical fiber 104 is transmitted through the convex portion 122 of the fiber 104, into the corresponding concave portion 123 on the rear surface 125 of the display 106 (as indicated by the arrows in FIG. 7b). The light continues onward into the plurality of fiber tubes 120 (in this case, seven) forming the display pixels of the video display 106. Light is then emitted from the ends of the fiber tubes 120. Additional information relating to optical coupling of fibers with a plurality of fiber tubes forming a display is included in U.S. Pat. No. 5,841,921 to Wallace, which is hereby incorporated by reference in its entirety, as if fully set forth herein.

The magnified display 100 is configured to magnify the image generated by the video source 102 such that it is displayed on the video display 106 in a magnified format. Magnification is accomplished by multiplying the light transmitted by one optical fiber 104 by seven as the light passes from the fiber 104 into the plurality of fiber tubes 120, as seen in FIG. 6. This multiplication permits the image generated by the video source 102 to be magnified and displayed by the video display 106 while preserving the resolution of the image. Thus, the magnified display 106 preserves the quality of graphical images generated by the video source 102 as it is transmitted through the video display 106 at a much larger size. The assembly and manufacture of such a magnified display 100 is included in U.S. Pat. No. 5,911,024 to Wallace, which is hereby incorporated by reference in its entirety, as if fully set forth herein.

The magnified display 100 may be utilized on a single free standing gaming machine 10. However, due the beneficial magnification properties of the display 100, the display 100 is preferably used as part of a gaming system which includes a plurality of gaming machines 10 linked together and including the magnified display 100 as a communal display visible by a plurality of players of the gaming machines 10. In this way, the magnified display 100 is used to display players' participation in group, competitive, collaborative, or shared experience gameplay. Additional information relating to video display transmission using optical fibers is included in U.S. Patent Application Publication 2003/0157980 A1, Ser. No. 10/077,443 (published on Aug. 21, 2003), which is hereby incorporated by reference in its entirety, as if fully set forth herein.

The lighting system 70 of the present invention offers substantial benefits over other lighting systems in that it may be configured such that a single light source 72 is used to generate light for all of the light emitters 76 of the gaming machine 10. This offers a substantial savings in costs and time of maintenance and repair in that individual lights of the gaming machine 10 need not be serviced independently. The magnified display 100 of the present invention offers the significant improvement of magnification without loss of resolution. Furthermore, the magnified display 100 offers cost savings because the optical fibers do not burn out, never need replacement, and consume no power, thus maintenance and operating costs are greatly reduced.

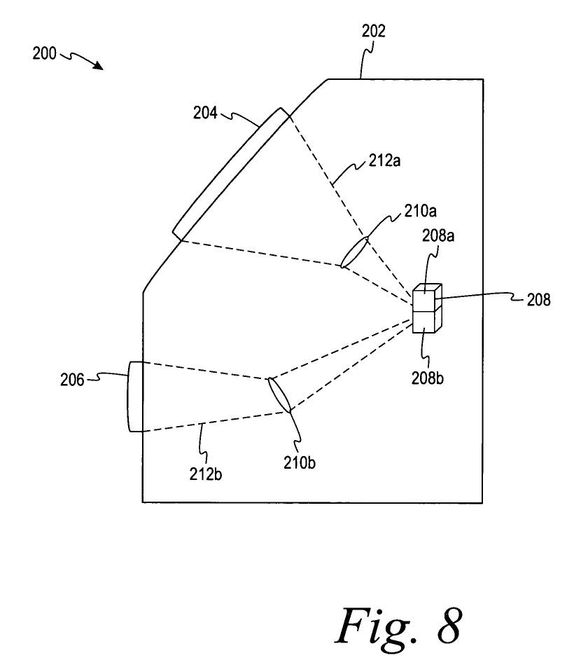

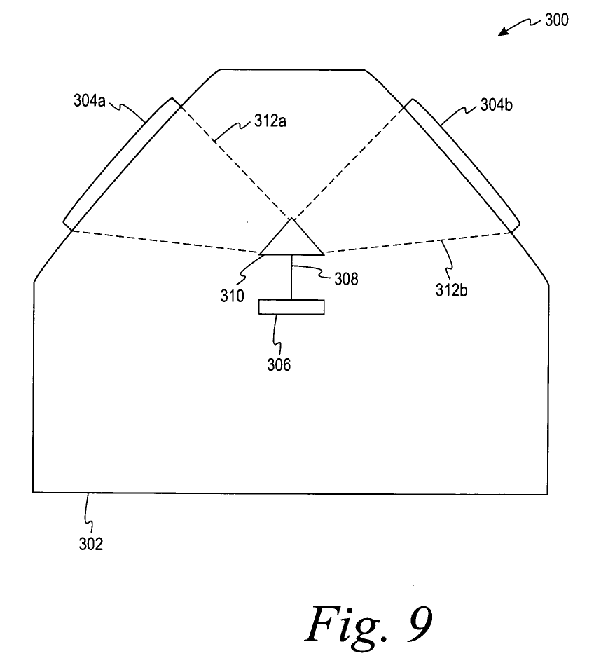

Turning now to FIG. 8, an alternative embodiment of a gaming machine 200 incorporating the present invention is illustrated. The gaming machine 200 includes a housing 202 that houses a primary display unit 204 and a secondary display unit 206. The primary display unit 204 and the secondary display unit 206 are generally comprised of a transparent substrate such as glass, plastic, or other transparent material.

The primary display unit 204 may display information about the basic wagering game and can also display information about a bonus wagering game and a progressive wagering game. The size of the primary display unit 204 may vary and may be customized for different types of gaming machines 200. The secondary display unit 206 may display game events, basic or bonus game outcomes, and/or signage information. The size and aspect ratios of the secondary display unit 206 may be the same as or different from those of the primary display unit 204. For example, the aspect ratio of the primary display unit 204 may be 16:9 and the aspect ratio of the secondary unit 206 may be 4:3. Like the primary display unit 204, the secondary display unit 206 may vary in size and may be customized for particular uses in different gaming machines 200. The image that will eventually be displayed on the primary and secondary display units 204, 206 may be configured to fit differently sized display units, as will be described below.

A projection source 208 is located generally within the housing 200. The projection source 208 emits visible light of one or more colors or wavelengths and projects an image(s) that eventually comprise the image(s) projected onto the primary and secondary display units 204, 206. In an embodiment, the projection source 208 includes a microdisplay capable of displaying multiple graphical images or color regions simultaneously. Microdisplays suitable for use in the embodiments shown and described in connection with FIGS. 8-9 are available from Kopin Corporation, Seiko Epson Corp., and eLCOS, for example. A microdisplay includes a small, light-producing or light-reflecting substrate that employs electro-optical effects to produce an image that can be projected onto a transparent substrate through optical magnification or projected “near to the eye” as in NTE applications without magnification. The light generating/reflecting element in the projection source 208, may include an electroluminescence source, a vacuum fluorescence source, a substrate having tilting or deforming micro-mirrors (DMD), a digital light processing (DLP) source, a liquid-crystal-on-silicon (LCoS) substrate, a plasma display, an incandescent source, a high-intensity LED, an LCD display, a silicon-based organic LED (“OLED”) display, and a laser. In some embodiments, the projection source 208 includes one or more light sources (such as LED arrays) whose light is emitted through a series of condensing and shaping lenses and filters and then reflected or bounced off of a digital micromirror device comprising millions of micromirrors that deflect light through a projection lens and onto a display screen.

In the illustrated embodiment, the projection source 208 has two source areas 208a,b which may be configured to produce two different graphic images. Although, the source areas 208a,b of the projection source 208 are shown as equally sized, the source areas 208a,b may be of varying sizes. Furthermore, the number of source areas 208a,b may also be varied according to the number of display units (e.g., 204, 206) in the gaming machine 200. In the illustrated embodiment, a first source area 208a corresponds to the primary display unit 204 and a second source area 208b corresponds to the secondary display unit 206.

First and second optics 210a,b are optically coupled to the projection source 208 to magnify the image emitted from the projection source 208 into a size that is suitable for viewing on the display units 204, 206. The first optics 210a is generally located between the first source area 208a of the projection source 208 and the primary display unit 204. The second optics 210b is located generally between the second source area 208b of the projection source 208 and the secondary display unit 206. Generally, the light path between the source area 208a,b and the respective display unit 204, 206 should be unobstructed.

The first optics 210a is adapted to magnify and project the image displayed by the first source area 208a (illustrated as dashed lines 212a) onto the primary display unit 204 for visual display to a player of the gaming machine 200. Depending on the size of the primary display unit 204 of the gaming machine 200, the optics 210a may be varied so that the image projected from the first source area 208 is magnified and projected to a size that fits within the viewable surface of the primary display unit 204. In an embodiment, the optics 210a,b include a lens or an arrangement of lenses and optionally one or more mirrors or prisms that are positioned and dimensioned to magnify the image emanating from the projection source 208 to a size that substantially occupies the viewable surface of the display units 204, 206 and to project that image onto the display units 204, 206. The lens components may be motorized to permit, under control of a controller such as the CPU 34, real-time adjustments of the size of the projected image to accommodate larger or smaller viewable display areas on the display units 204, 206.

The second optics 210b are adapted to magnify and project an image associated with the second source area 208b onto the secondary display unit 206 (illustrated as dashed lines 212b). The second optics 210b may also be configured so that the image from the second source area 208b is magnified to correspondingly fit onto differently sized secondary display units 206. Generally, the configuration of the gaming machine 200 allows for an image produced from a non-customized source size (i.e., projection source 208) to be magnified and projected onto differently sized display units (i.e., 204, 206).

The single projection source feeding multiple display unit embodiments shown and described in connection with FIG. 8 offers several advantages. First, the size of each display unit is not constrained by the market availability of predetermined LCD sizes. The transparent substrate of each display unit can be shaped to any size and shape. Second, the projection source is housed and protected within the gaming machine cabinet, greatly reducing the possibility of breakage. Note that the actual projection source is typically invisible to the player; what the player perceives visually is actually light that is reflected, distorted, and/or guided through lenses, mirrors, and the like from the projection source to the display unit. Third, providing one source to feed multiple display units reduces overall power consumption versus using a one-to-one correspondence between display source and display unit. Fourth, only one projection source needs to be serviced or repaired for multiple display units. Fifth, the overall size of the gaming machine cabinet can be reduced in embodiments utilizing a microdisplay because the microdisplay itself is very small and a single microdisplay is used for displaying images on multiple, distinctly situated display units. Mirrors, prisms, or other reflective elements can be used to reduce distances required between the microdisplay and the magnifying lenses to further reduce the amount of open space required within the cabinet.

Turning now to FIG. 9, an additional embodiment of a multi-player gaming machine 300 is shown. The gaming machine 300 includes a housing 302 having a first primary display unit 304a and a second primary display unit 304b. The primary display units 304a,b may be juxtaposed relative to one another, opposite one another or positioned in some other way relative to each other. Preferably, the primary display units 304a,b are positioned in a way that enables a player to use each primary display unit 304a,b simultaneously. Accordingly, in this embodiment, two (2) players may play the gaming machine 300 simultaneously. In other embodiments, more primary display units 304 may be provided to enable more players to simultaneously play the gaming machine 300. Also, secondary display units (as illustrated in FIG. 8 and described in relation to FIG. 8) may also be provided in the gaming machine 300 in some embodiments.

The gaming machine 300 further includes a projection source 306 located therewithin. Like the projection source 208, the projection source 306 emits visible light of one or more colors or wavelengths and displays an image(s) that eventually becomes the image(s) projected onto the primary display units 304a,b. The projection source 306 may project single or multiple images and may comprise any type of microdisplay. Preferably, the projection source 306 is an LCD display, but may alternatively be any form of light producing elements listed above in connection with the projection source 208. An optics divider 308 optically divides the images displayed by the projection source 306 for projection onto the primary display units 304a,b. In this manner, an image displayed on a first half of the projection source 306 is projected onto one of the display units 304a,b, while simultaneously an image displayed on the other half of the projection source 306 is projected onto the other of the display units 304a,b. In embodiments having more than two primary display units 304a,b than illustrated, the optics divider 308 is configured to optically divide the images to the display units 304a,b. It may be, for example, a piece of material, such as plastic, having a non-reflective, dark surface, which is positioned over the projection source 208 (such as at its midpoint) to prevent images from one section of the projection source 208 from combining with images from the other section of the projection source.

After the optics divider 308, the images encounter a prism 310. The prism 310 reflects and magnifies the images received from the projection source 306 and divided by the optics divider 308 to their respective primary display units 304a,b. Other means of reflecting and magnifying the images from the projection source 306 may be utilized and are also contemplated as falling within the present invention. In the illustrated embodiment, the image reflected to the primary display unit 304a is illustrated via dashed lines 312a and the image reflected to the primary display unit 304b is illustrated via dashed lines 312b. Essentially, the optics divider 308 together with the prism 310 are operable to magnify and project distinct images outputted by a single source, i.e., the projection source 306, onto multiple display units, i.e., primary display units 304a,b in the illustrated embodiment.

In another embodiment in which an optics divider is not necessary, the projection source 308 is a microdisplay over which a film is placed that permits one image to be viewed at a first viewing angle and other image to be viewed at a second viewing angle that is different from the first viewing angle.

The gaming machine 300 described above can output onto the display units 304a,b images having virtually any size from a standard-sized projection source 306 without customizing the projection source 306 to the desired display size.

Each of these embodiments and obvious variations thereof is contemplated as falling within the spirit and scope of the claimed invention, which is set forth in the following claims.

What is claimed is:

1. A gaming machine comprising:
a housing;
a light source coupled to the housing, the light source emitting at least one color of visible light;
a first light emitter coupled to the housing;
a second light emitter coupled to the housing;
a first plurality of optical fibers having first ends optically coupled to the light source and second ends optically coupled to the first light emitter; and
a second plurality of optical fibers having first ends optically coupled to the light source and second ends optically coupled to the second light emitter.

2. The gaming machine of claim 1, wherein the light source is selected from the group consisting of an incandescent light, a CRT display, a plasma display, an LED, an organic LED, and a laser.

3. The gaming machine of claim 1, wherein the light source is an LCD display.

4. The gaming machine of claim 3, wherein a first portion of the LCD display generates a first color of visible light and a second portion of the LCD display generates a second color of visible light.

5. The gaming machine of claim 4, wherein the first ends of the first plurality of optical fibers is adjacent to the first portion of the LCD display and the first ends of the second plurality of fibers is adjacent the second portion of the LCD display.

6. The gaming machine of claim 5, wherein the first light emitter transmits the first color and the second light emitter transmits the second color.

7. The gaming machine of claim 1, wherein the first and second light emitters are chosen from the group consisting of a tower light, a button, a button panel, a service light, an interior light, an exterior cabinet light, a marquee light, a top box light, a game sign, and a progressive display.

8. The gaming machine of claim 7, wherein the first and second light emitters are different.

9. The gaming machine of claim 1, wherein the light source is mounted inside the housing.

10. A gaming machine comprising:
a housing;
at least one light source coupled to the housing, the light source emitting visible light;
a first emitter coupled to a first portion of the housing;
a second emitter coupled to a second portion of the housing;
a first plurality of optical fibers having first ends optically coupled to the light source and second ends optically coupled to the first light emitter; and
a second plurality of optical fibers having first ends optically coupled to the light source and second ends optically coupled to the second light emitter.

11. The gaming machine of claim 10, wherein the first and second portions of the housing are distinct and physically spaced from one another.

12. The gaming machine of claim 10, wherein the at least one light source is selected from the group consisting of an LCD display, an incandescent light, a CRT display, an LED, a organic LED, and a laser.

13. The gaming machine of claim 10, wherein the first emitter and second emitter are different types of emitters.

14. The gaming machine of claim 10, wherein the first and second light emitters are selected from the group consisting of a tower light, a button, a button panel, a service light, an interior light, an exterior cabinet light, a marquee light, a top box light, a game sign, and a progressive display.

15. The gaming machine of claim 14, wherein the first and second light emitters are different.

16. A gaming system comprising:
a value input device for receiving a wager;
a video source generating a representation of a randomly-selected outcome selected from a plurality of possible outcomes, the plurality of outcomes including at least one winning outcome;
a video display for displaying the representation, the video display comprising an array of fiber tubes, the fiber tubes arranged in groups within the array; and
a plurality of optical fibers having first ends and second ends, each first end optically coupled to the video source and each second end optically coupled to a respective one of the groups of fiber tubes.

17. The gaming system of claim 16, wherein the video source is selected from the group consisting of an LCD display, an incandescent light display, a CRT display, a plasma display, an LED display, an organic LED display, and a laser display.

18. The gaming system of claim 16, wherein each group of fiber tubes includes a central tube and a plurality of outer tubes circumferentially arranged about the central tube.

19. The gaming system of claim 16, wherein the second end of each of the optical fibers comprises a convex portion.

20. The gaming system of claim 19, wherein the convex portions are optically coupled to a plurality of concave portions on a rear surface of the video display, each concave portion coupled to one of the groups of fiber tubes.

21. A gaming machine comprising:
a housing;
a projection source disposed in the housing, the projection source emitting at least one image relating to a wagering game that is played on the gaming machine;
a primary display unit coupled to a first portion of the housing;
a secondary display unit coupled to a second portion of the housing;
a first optics disposed generally between the projection source and the primary display unit, the first optics magnifying images emitted by the projection source for display on the primary display unit; and
a second optics disposed generally between the projection source and the secondary display unit, the second optics magnifying images emitted by the projection source for display on the secondary display unit.

22. The gaming machine of claim 21, wherein the projection source includes a display selected from the group consisting of an electroluminescence source, a vacuum fluorescence source, a substrate having tilting or deforming micro-mirrors (DMD), a digital light processing (DLP) source, a liquid-crystal-on-silicon (LCoS) substrate, a plasma display, an incandescent source, a high-intensity LED, an LCD display, a silicon-based organic LED (“OLED”) display, and a laser.

23. The gaming machine of claim 21, wherein the projection source includes a microdisplay.

24. The gaming machine of claim 23, wherein the projection source includes a first source area that emits a first set of images relating to the wagering game and a second source area that emits a second set of images relating to the wagering game, the first set of images being displayed on the primary display unit, the second set of images being displayed on the secondary display unit.

25. The gaming machine of claim 21, wherein the primary display unit includes a transparent substrate and the secondary display unit includes a transparent substrate.

26. A gaming machine comprising:
a first wager input device for receiving a wager to play a first wagering game on the gaming machine;
a second wager input device for receiving a wager to play a second wagering game on the gaming machine, the second wagering game capable of being played concurrently with the first wagering game;
a housing;
a projection source disposed in the housing, the projection source emitting an image relating to the first wagering game or the second wagering game;
at least two display units coupled to the housing;
an optics divider optically coupled to the projection source to divide the image into a number of image sections corresponding to the number of display units; and
optics optically coupled to the optics divider to magnify and project a first image section of the image sections to a first one of the display units and a second image section of the image sections to a second one of the display units.

27. The gaming machine of claim 26, wherein the at least two display units is exactly two display units, the two display units being disposed on opposite sides of the gaming machine.

28. The gaming machine of claim 26, wherein the optics include a prism.

29. The gaming machine of claim 26, wherein the projection source includes a microdisplay.
